(19) United States
(12) Patent Application Publication
(10) Pub. No.: US 2016/0241833 A1
(43) Pub. Date: Aug. 18, 2016

(54) RENDERING METHOD AND RENDERING DEVICE

(71) Applicant: SAMSUNG ELECTRONICS CO., LTD., Suwon-si (KR)

(72) Inventors: Ji Won KIM, Suwon-si (KR); Dong Kyung NAM, Suwon-si (KR); Du Sik PARK, Suwon-si (KR)

(73) Assignee: Samsung Electronics Co., Ltd., Suwon-si (KR)

(21) Appl. No.: 15/027,164

(22) PCT Filed: May 2, 2014
(86) PCT No.: PCT/KR2014/003916

§ 371 Date: Apr. 4, 2016

(30) Foreign Application Priority Data
Oct. 4, 2013 (KR) 10-2013-0118828

(51) Int. Cl. H04N 13/00; G06T 15/40; H04N 13/04; G06T 15/06

(52) U.S. Cl. CPC H04N 13/0018; G06T 15/06; G06T 15/405; H04N 13/0404; H04N 13/0468

(57) ABSTRACT

A method and a device for rendering are provided. An image can be generated by cone tracing which is beam tracing using a cone having a thickness. The thickness of the cone can be adjusted such that a hole is not generated in the image.

### TECHNICAL FIELD

Example embodiments of the following description relate to a method and apparatus for processing an image, and more particularly, to a method and apparatus for performing rendering on the image.

### BACKGROUND ART

Various methods have been used to process a three-dimensional (3D) image or video such as a light field, an integral imaging, a stereo, and a multi-view, for example.

In terms of rendering a 3D image or video based on an actual image, a predetermined portion of the image may not include information for determining characteristics of the portion. For example, a hole may occur in an image generated through the rendering.

In comparison to other rendering methods, ray tracing is widely used for rendering. The hole may also occur in an image generated using a 3D image processing method adopting the ray tracing. Accordingly, a process of hole-filling may be required to eliminate the hole.

### DISCLOSURE OF INVENTION

### Technical Solutions

The foregoing and/or other aspects are achieved by providing a method of rendering including generating an image by performing cone tracing indicating beam tracing performed using a cone having a thickness, determining whether a hole is present in the generated image, and increasing the thickness when the hole is present in the generated image.

The generated image may be a light field image.

The rendering may be a rendering for an integral imaging.

The generated image may be one of stereoscopic images.

The generated image may be one of multi-view images.

The generating, the determining, and the increasing may be repetitively performed until the hole is no longer present in the generated image.

When information associated with a plurality of cones arrives at a partial area of the generated image, information associated with a cone selected from among the plurality of cones may be used for the partial area based on a predetermined condition.

The partial area may be a pixel included in the generated image.

The selected cone may be a first cone to arrive at the partial area, among the plurality of cones while the generating is being performed repetitively.

The selected cone may be a cone having the smallest distance between a center of the cone and the partial area, among the plurality of cones.

The selected cone may be a cone corresponding to a point having the smallest distance from an observer of the generated image, among points from which the plurality of cones departs.

The selected cone may be determined through a z-buffering on the partial area.

The method of rendering may further include initializing the thickness of the cone.

The foregoing and/or other aspects are also achieved by providing an apparatus for rendering including a tracing unit to generate an image by performing cone tracing indicating beam tracing using a cone having a thickness, wherein the tracing unit may determine whether a hole is present in the generated image, and increase the thickness when the hole is present in the generated image.

The generated image may be a light field image.

The tracing unit may repetitively perform the generating, the determining, and the increasing until the hole is no longer present in the generated image.

The apparatus for rendering may further include a selecting unit to select a cone to be used for a partial area of the generated image, from among a plurality of cones based on a predetermined condition when information associated with the plurality of cones arrives at the partial area of the generated image.

The partial area may be a pixel included in the generated image.

The selected cone may be a first cone to arrive at the partial area, among the plurality of cones, while the generating is being performed repetitively.

The selected cone may be a cone having the smallest distance between a center of the cone and the partial area, among the plurality of cones.

The selected cone may be a cone corresponding to a point having the smallest distance from an observer of the generated image, among points from which the plurality of cones departs.

The foregoing and/or other aspects are also achieved by providing an apparatus for rendering including a tracing unit to generate an image by performing cone tracing indicating beam tracing using a cone having a thickness, wherein the cone may have a thickness adjusted by the tracing unit such that a hole does not occur in the image.

### BRIEF DESCRIPTION OF DRAWINGS

FIG. 1 illustrates an original image and a three-dimensional (3D) rendered image according to example embodiments.

FIG. 2 illustrates a cone according to example embodiments.

FIG. 3 illustrates a principle of cone tracing according to example embodiments.

FIG. 4 illustrates a trace device according to example embodiments.

FIG. 5 illustrates a method of rendering according to example embodiments.

FIG. 6 illustrates an arrival of cones in a first repetition according to example embodiments.

FIG. 7 illustrates an arrival of cones in a second repetition according to example embodiments.

FIG. 8 illustrates an arrival of cones in a third repetition according to example embodiments.

FIG. 9 illustrates a distance between a partial area and each cone according to example embodiments.

FIG. 10 illustrates a relationship between a cone and a point of an object according to example embodiments.

### BEST MODE FOR CARRYING OUT THE INVENTION

Hereinafter, example embodiments will be described in detail with the accompanying drawings, wherein like reference numerals refer to like elements throughout.

Example embodiments described below may be applied to rendering of a stereo image, a multi-view image, and a light field image, and used for rendering based on an integral imaging, one of methods of light field rendering.

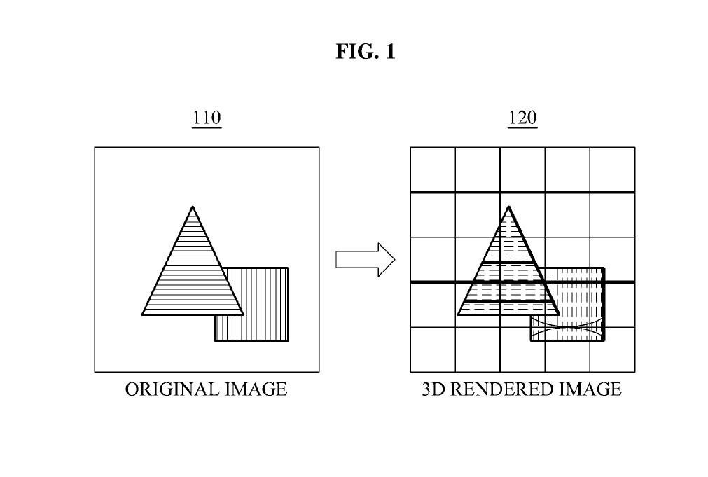

FIG. 1 illustrates an original image and a three-dimensional (3D) rendered image according to example embodiments.

Referring to FIG. 1, when the 3D rendered image is generated based on an original image 110, a hole region may occur in a 3D rendered image 120.

In the 3D rendered image 120, the hole region may be indicated by bold lines. The bold lines of the 3D rendered image 120 may not be shown in the original image 110. The bold lines may be a portion in which information for use in rendering is not acquired using the original image 110.

Descriptions about a principle of a computer-based composite with respect to a scene of a light field video will be provided as below. Here, the scene may be a 3D image.

A ray may pass through a micro-lens, starting from a point of an object. The ray may be stored to be information associated with a pixel of the 3D image.

An overall size of the 3D image may correspond to a size of a micro-lens array (MLA). For example, the 3D image may include at least one micro-lens image.

A number of micro-lens images may be identical to a number of micro-lenses included in the MLA. Also, an area of the micro-lens image may correspond to an area of a micro-lens positioned in front of the micro-lens image.

A beam in a form of the ray may pass through a center of the micro-lens, starting from a point of an object. The beam passing through the center of the micro-lens may be mapped to a predetermined portion of a panel. A portion at which the ray does not arrive may be included in the predetermined portion of the panel. The portion at which the ray does not arrive may not include information for determining characteristics of the portion. A hole may occur in the portion at which the ray does not arrive.

The aforementioned portion at which the ray does not arrive may correspond to a partial area of the 3D image. The partial area may be a pixel, and the pixel may be singular or plural. For example, when the 3D image such as a multi-view glassless 3D image is generated, information associated with an area adjacent to a hole region of the 3D image may be used to incorporate information in the hole region. The information may be incorporated in the hole region through hole filling or in-painting using the information associated with an adjacent area. However, since neighboring pixels in the panel may not correspond to neighboring voxels in a 3D space, applying a scheme of using the information associated with an adjacent area to a generalized light field rendering may be inappropriate. For example, when two neighboring pixels in a panel do not correspond to neighboring voxels in a 3D space, a fatal error in view of the 3D image may be caused by using information associated with one of the two neighboring pixels to incorporate information associated with the other pixel.

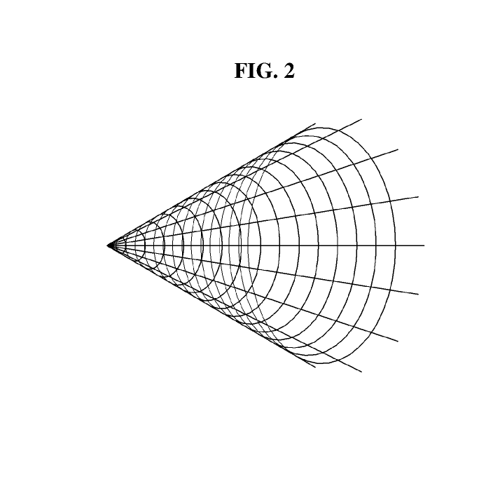

FIG. 2 illustrates a cone according to example embodiments.

Referring to FIG. 2, the cone may have a thickness. Cone tracing may refer to beam tracing using the cone having a thickness. The cone may be provided in a shape of a circular cone or a quadrangular pyramid. The thickness of the cone may vary based on a distance between a panel and an object emitting the cone. For example, the thickness of the cone may be increased in proportion to an increase in the distance between the panel and the object emitting the cone. The thickness of the cone may indicate a maximum angle between beams emitted from the object, or a proportional value of the maximum angle.

Since the cone has the thickness, the cone may be processed as a plurality of beams emitted from a point of the object.

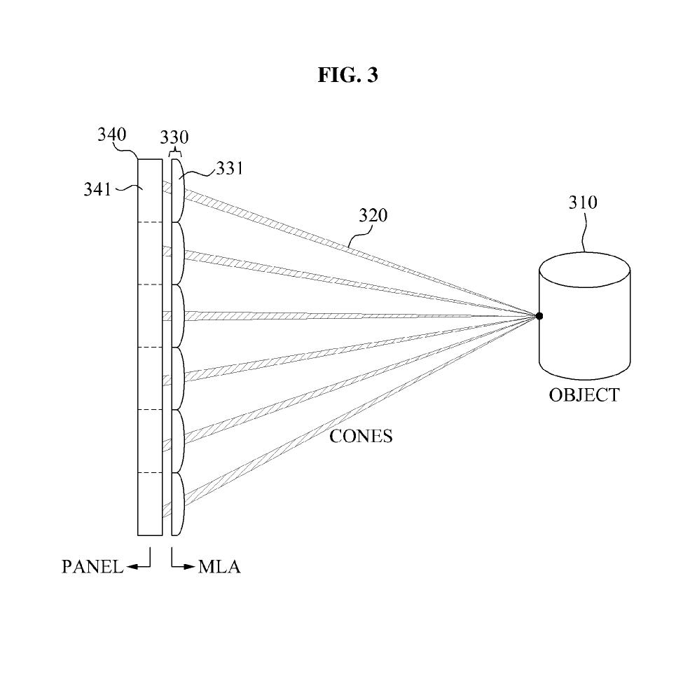

Hereinafter, description about a principle of the cone tracing will be provided with reference to FIG. 3.

FIG. 3 illustrates a principle of cone tracing according to example embodiments.

Referring to FIG. 3, cones may be emitted from a point of an object 310. Each of the cones emitted from the point of the object 310 may have a thickness. Each of the cones may pass through a center of a micro-lens included in an MLA 330. Each of the cones may be stored to be information associated with at least one pixel included in a 3D image.

An overall size of the 3D image may correspond to a size of the MLA 330. For example, the 3D image may include at least one micro-lens image. A panel 340 may include at least one partial panel. The micro-lens image may be focused on each partial panel.

A number of micro-lens images may be identical to a number of micro-lenses included in the MLA 330. Also, an area of the micro-lens image may correspond to an area of the micro-lens positioned in front of the micro lens image.

In MLA 330, the micro-lenses may be two-dimensionally (2D) arranged. For example, the MLA 330 may include m micro-lenses in width and n micro-lenses in length, that is, m*n micro-lenses. Each of m and n may be a whole number greater than or equal to “2”.

In FIG. 3, a first cone 320 emitted from a point of the object 310 may pass through a center of a first micro-lens 331. The first cone 320 may arrive at a first partial panel 341. The first cone 320 may be stored to be information associated with at least one pixel included in a micro-lens image focused on the first partial panel 341.

Each beam in a form of the cone may be emitted from the point of the object 310 and pass through a center of the micro-lens included in the MLA 330. Each beam passing through the center of the micro-lens may be mapped to a portion of a panel.

A portion to which the beam is mapped may correspond to at least one pixel included in the 3D image. When the beam is a ray, the portion to which the beam is mapped may be indicated using coordinates. The portion to which the beam is mapped may correspond to one pixel included in the 3D image. Since the cone has a thickness, when the beam is the cone, the portion to which the beam is mapped may correspond to a plurality of pixels of the 3D image. A number of pixels corresponding to the portion to which the beam is mapped may increase according to an increase in a thickness of the cone. The plurality of cones may be pixels included in a partial area to which the beam is mapped.

When the beam is a cone, a size of an area of a panel to which a single beam is mapped may be increased according to an increase in a thickness of the cone. Thus, when the thickness of the cone is increased, a size of an area of the panel at which the beam does not arrive may be reduced. When the thickness of the cone corresponds to a value greater than or equal to a predetermined value, the area at which the beam does not arrive may no longer be present. Thus, the hole may not occur in the 3D image.

Hereinafter, descriptions about a method and apparatus for performing cone tracing indicating beam tracing using the cone will be provided.

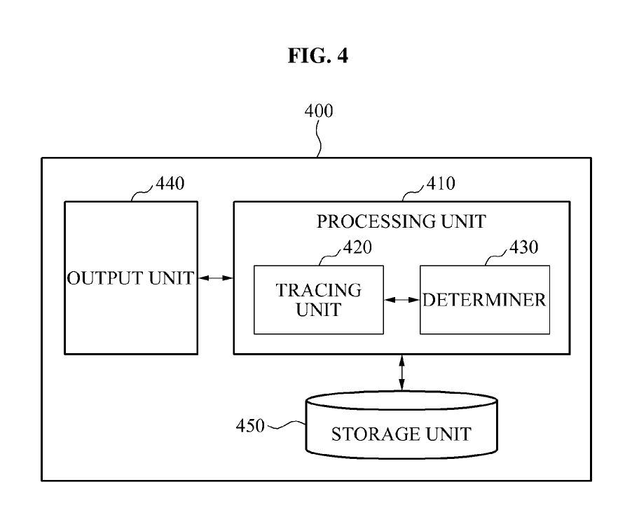

FIG. 4 illustrates a trace device according to example embodiments.

Referring to FIG. 4, a trace device 400 may include a processing unit 410, an output unit 440, and a storage unit 450.

The processing unit 410 may generate an image by performing cone tracing. The image may be a 3D image.

For example, the generated image may be a light field image, and rendering may be rendering for an integral imaging. The integral imaging may be a scheme of forming a light field by integrating points included in a space using a lens array and a basic image. The basic image may be an image captured by the panel 340. When the basic image is represented using a display device and the MLA 330 is arranged in front of the display device, an integral image may be represented.

The generated image may be one of stereoscopic images. Alternatively, the generated image may be one of multi-view images.

The output unit 440 may provide the generated image.

The storage unit 450 may store data used to generate an image and data associated with the generated image.

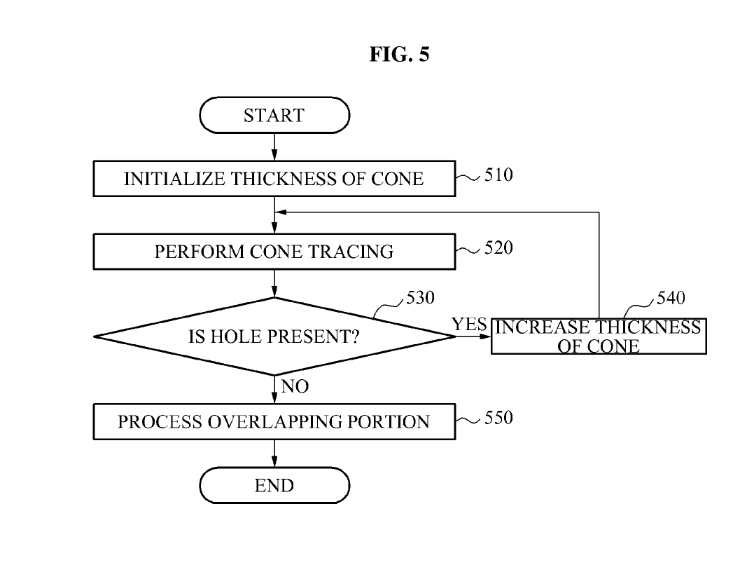

The processing unit 410 may include a tracing unit 420 and a determiner 430. Hereinafter, description about functions of the tracing unit 420 and the determiner 430 will be provided with reference to FIG. 5.

FIG. 5 illustrates a method of rendering according to example embodiments.

Referring to FIG. 5, in operation 510, the tracing unit 420 may initialize a thickness of a cone for use in tracing.

The initialized thickness of the cone may be a thickness mapped to a single point or a single pixel. For example, the cone having the initialized thickness may provide a function identical to a function of a ray.

The cone may be provided in a shape of a circular cone or a quadrangular pyramid. For example, the cone may be mapped to pixels included in a circular cone-shaped area or a quadrangular pyramid-shaped area. Based on a shape of the cone, information associated with the cone may arrive at the pixels included in the circular cone-shaped area or the quadrangular pyramid-shaped area. In terms of tracing, when the information associated with the cone arrives at a pixel or an area, a cone emitted from an object may arrive at the pixel or the area.

The information associated with the cone may include information indicating an intensity of a beam passing through a spatial area. The information associated with the cone may include, for example, a 3D location of a spatial area, a direction of a beam, and a time and a wavelength related to a color. The spatial area may include at least one spatial point. For example, the information associated with the cone may include information associated with a direction and an intensity of each beam emitted from an object of the spatial area. The information associated with the cone may include radiance value of a five dimensional coordinate system related to the spatial area.

In operation 520, the tracing unit 420 may generate the image by performing the cone tracing indicating the beam tracing using the cone having the thickness.

The generated image may be the 3D image. For example, the generated image may be a light field image, and the rendering may be the rendering for the integral imaging.

The generated image may be one of the stereoscopic images. Alternatively, the generated image may be one of the multi-view images.

In operation 530, the tracing unit 420 may determine whether a hole is present in the generated image. For example, the tracing unit may determine whether a predetermined condition with respect to the generated image is satisfied. The predetermined condition may indicate an absence of the hole in the generated image.

The hole may be a portion at which information associated with the cone does not arrive.

When the hole is present in the generated image, operation 530 may be performed. When the hole is no longer present in the generated image, operation 550 may be performed.

When the hole is present in the generated image, the tracing unit 420 may increase the thickness of the cone in operation 540.

The thickness of the cone may be increased based on a predetermined unit. For example, the thickness of the cone may be increased by one pixel. In addition, the thickness of the cone may be increased based on a unit for use in measuring the image. An increase in the thickness of the cone may be indicated using a unit such as centimeters (cm) and millimeters (mm) for use in measuring a length.

Subsequent to operation 540, operation 520 and operation 530 may be performed repetitively. For example, the generating in operation 520, the determining in operation 530, and the increasing in operation 540 may be repetitively performed until the hole is no longer present in the image generated through the cone tracing. The tracing unit 420 may repetitively perform the generating of the image, the determining whether the hole is present, and the increasing of the thickness of the cone until the hole is no longer present in the generated image.

In operations 510 through 540 the tracing unit 420 may generate the image perform the cone tracing indicating the beam tracing using the cone having the thickness. The thickness of the cone may be adjusted by the tracing unit 420 such that the hole does not occur in the image.

In operation 550, a portion in which information associated with the cone overlaps of the generated image may be processed. When information associated with a plurality of cones arrives at a partial area of the generated image, the determiner 430 may select a cone to be used for the partial area from among the plurality of cones based on a predetermined condition. The determiner 430 may determine a priority for the plurality of cones in the partial area of the generated image.

Although not shown in FIG. 5, operation 520 and operation 550 may be performed in parallel. For example, when the image is generated by the tracing unit in operation 520, the determiner 430 may select the cone including information used for the partial area in which information associated with the cone overlaps of the generated image.

The partial area may be at least one pixel. The partial area may be an area of a micro-lens image.

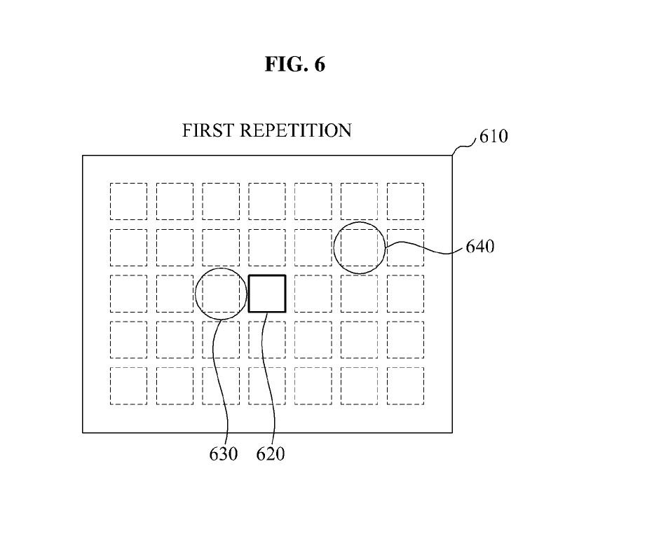

Hereinafter, description about a method of selecting a cone will be provided with reference to FIGS. 6 through 10.

FIG. 6 illustrates an arrival of cones in a first repetition according to example embodiments.

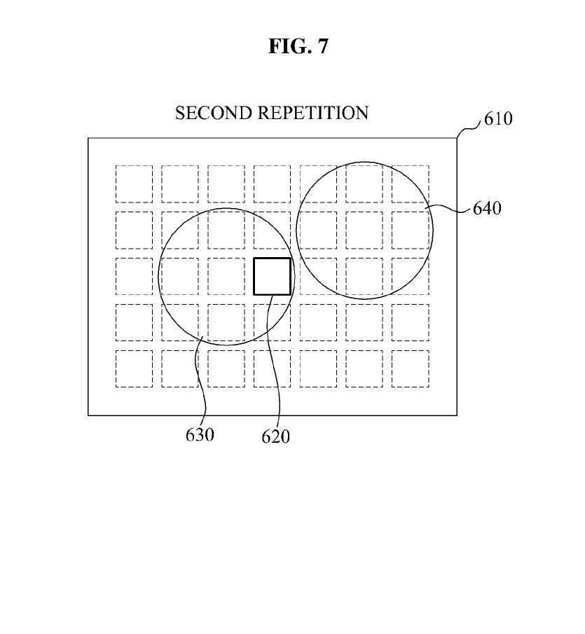

FIG. 7 illustrates an arrival of cones in a second repetition according to example embodiments.

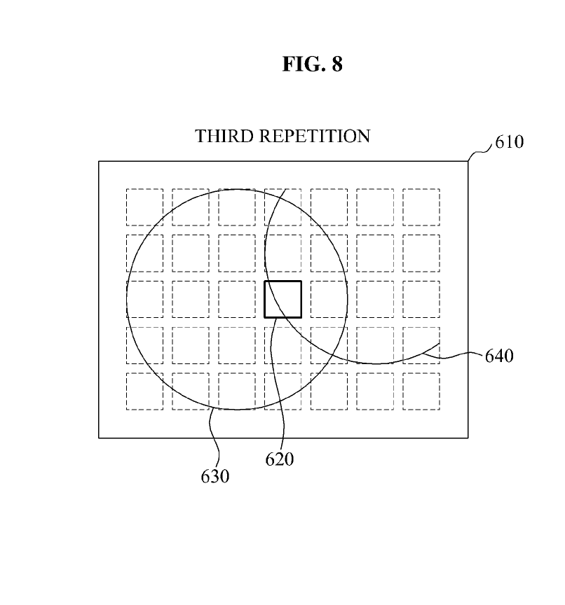

FIG. 8 illustrates an arrival of cones in a third repetition according to example embodiments.

Referring to FIGS. 6 through 8, first cone information 630 and second cone information 640 may arrive at a first partial area 620 of an image 610.

Hereinafter, a repetition may indicate that operation 520 of FIG. 5 is performed repetitively. For example, a state in which operation 520 is performed once for the image 610 may be indicated with reference to FIG. 6. A state in which operation 520 is performed twice for the image 610 may be indicated with reference to FIG. 7. A state in which operation 520 is performed three times for the image 610 may be indicated with reference to FIG. 8.

The image 610 may include a plurality of partial areas. The first partial area 610 may be a partial area at which information associated with a plurality of cones arrives, among the plurality of cones. Each of the plurality of partial areas may be a pixel.

In FIG. 6, remaining areas, aside from the first partial area 620 among the plurality of areas may be indicated by a rectangular portion with a dotted line.

As described in FIG. 6, in a first repetition, first cone information 630 and second cone information may not arrive at the first partial area 620.

As described in FIG. 7, in a second repetition, the first cone information 630 may arrive at the first partial area 620, and the second cone information may not arrive at the first partial area 620.

As described in FIG. 7, in a third repetition, the first cone information 630 and the second cone information may arrive at the first partial area 620.

Accordingly, a first cone may be positioned close to the first partial area 620 when compared to a second cone, and using the first cone information 630 for the first partial area 620 may be more appropriate than using the second cone information 640 for the first partial area 620.

As described in FIGS. 6 through 8, in operation 550, the cone selected by the determiner 430 may be a first cone to arrive at a partial area among the plurality of cones while the generating is being performed repetitively in operation 520 of FIG. 4. For the partial area, the determiner 430 may use information associated with the first cone to arrive at the partial area among the plurality of cones.

When, at an area filled with information associated with a cone, information associated with another cone subsequently arrives, the subsequently arriving information may be ignored.

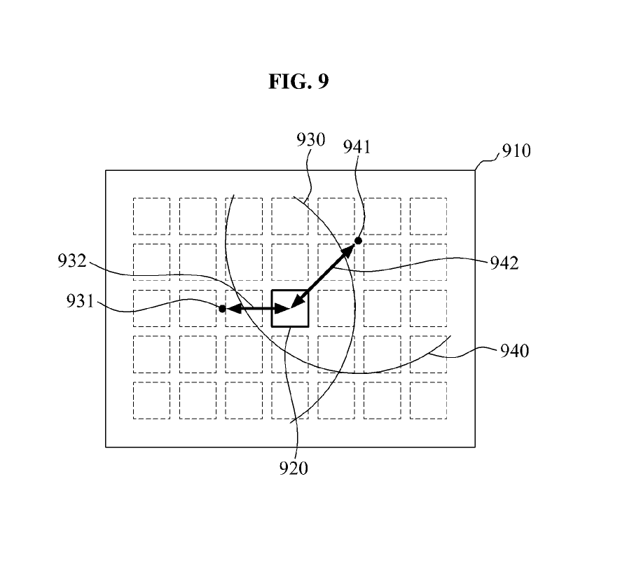

FIG. 9 illustrates a distance between a partial area and each cone according to example embodiments.

Referring to FIG. 9, third cone information 930 and fourth cone information 940 may arrive at a second partial area 920 of an image 910.

A first distance 932 may indicate a distance between a center 931 of a third cone and the second partial area 920. A second distance 942 may indicate a distance between a center 941 of a fourth cone and the second partial area 920.

A thickness of the third cone may be identical to a thickness of the fourth cone.

The second partial area 920 may be influenced in advance by a third cone having a distance from the second partial area 920 less than a distance of a fourth cone, when compared to the fourth cone. Alternatively, the second partial area 920 may be more influenced by the third cone having the distance from the second partial area 920 less than the distance of the fourth cone, when compared to the fourth cone. Thus, using the third cone information 930 for the second partial area 920 may be more appropriate than using the fourth cone information 940 for the second partial area 920.

In operation 550, the cone selected by the determiner may be a cone having the smallest distance between a center of the cone and the partial area, among the plurality of cones. The determiner 430 may use information associated with the cone having the smallest distance between a center of the cone and the partial area among the plurality of cones, for the partial area.

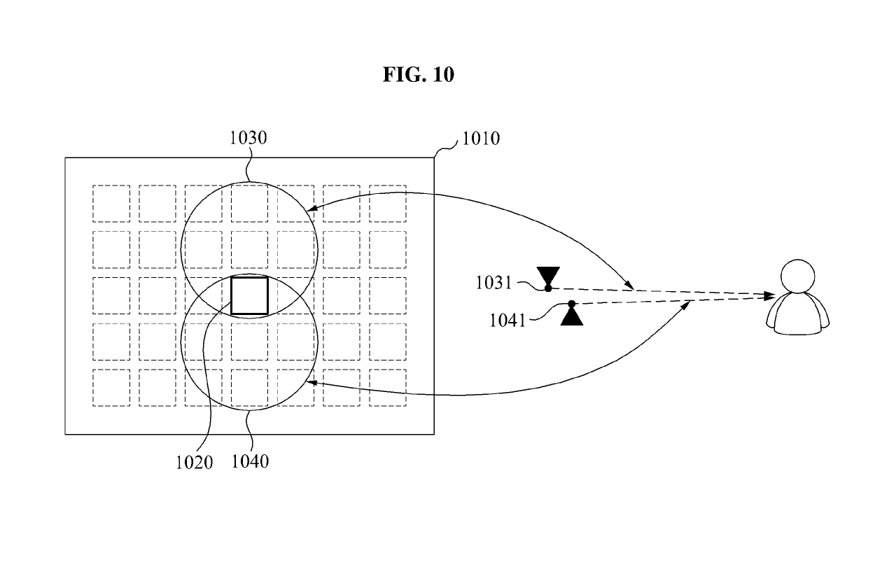

FIG. 10 illustrates a relationship between a cone and a point of an object according to example embodiments.

In FIG. 9, a fifth cone information 1030 and a sixth cone information 1040 may arrive at a third partial area 1020 of an image 1010. A fifth cone may be a cone departing from a first point 1031, and a sixth cone may be a cone departing from a second point 1041.

Referring to FIG. 10, the second point 1032 from which the sixth cone departs may be positioned closer to an observer than the first point 1031 from which the fifth cone departs.

The third partial area 1020 may be more influenced by the sixth cone departing from the second point 1032 positioned closer than the first point 1031, when compared to the fifth cone. Thus, using the sixth cone information 1040 for the third partial area 1020 may be appropriate.

In operation 550, the cone selected by the determiner 430 may be a cone corresponding to a point located at a distance closest to the observer of the generated image, among the plurality of points from which the plurality of cones departs. The determiner 430 may use, for the partial area, information associated with the cone corresponding to a point located at the distance closest to the observer of the generated image, among the plurality of points from which the plurality of cones departs.

The selected cone may be determined through a z-buffering for the partial area. The determiner 430 may use, for the partial area, information associated with the cone departing from the point located at the smallest distance from the observer of the generated image, among the plurality of points, through the z-buffering for the points from which the plurality of cones departs.

When first cone information arrives at a partial area and a first point from which a first cone departs is located closer to an observer than a second point stored in a buffer, information associated with the first point may be stored in the buffer. When the first point from which the first cone departs is not located closer to the observer than the second point stored in the buffer, the information associated with the first point and the first cone may not be stored in the buffer and may be abandoned.

The method for selecting a cone described with reference to FIGS. 6 through 10 may be used alone or in combination thereof.

For example, the determiner 430 may use, with respect to a plurality of cones arriving at a partial area of an image, at least one of a sub-sequence in an arrival of a cone, a thickness of the cone, a distance between the cone and the partial area, a distance between an observer and a point from which the cone departs, and a distance between a panel and the point from which the cone departs, thereby setting a priority for the plurality of cones. The determiner 430 may use, for the partial area of the image, information associated with a cone having the highest priority among the plurality of cones arriving at the partial area.

In terms of selecting the cone, the determiner 430 may set a priority for the aforementioned methods. For example, the determiner 430 may select, for the partial area of the image, a first cone to arrive at the partial area from among the plurality of cones, or select a cone having the smallest thickness from among the plurality of cones, as a selection.

As another selection, the determiner may select a cone having the smallest distance between a center of the cone and the partial area from among cones simultaneously arriving at the partial area in operation 520. As still another selection, the determiner 430 may select a cone departing from a point located at a distance closest to the observer of the generated image, from among cones having an identical distance between a center of each of the cones and the partial area, and arriving at the partial area simultaneously. Thicknesses of the cones arriving simultaneously in operation 520 may be equal. In the description provided above, cones arriving simultaneously may be substituted for with cones having an identical thickness.

Alternatively, the determiner 430 may select a cone departing from the point located at the distance closest to the observer of the generated image, from among cones simultaneously arriving in operation 520 as another selection. As still another selection, the determiner 430 may select a cone having the smallest distance between a center of the cone and the partial area from among cones having an identical distance between a center of each of the cones and the partial area, and arriving at the partial area simultaneously.

In the aforementioned methods, a subsequence in the selections may be changed in various patterns.

The determiner 430 may select at least two cones. For example, the determiner 430 may use, for the partial area, information associated with cones simultaneously arriving at the partial area in operation 530. Also, when the plurality of cones arrives at the partial area and distances between the partial area and the center of each of the plurality of cones are equal, the determiner 430 may use information associated with the cones for the partial area.

For example, the determiner 430 may use an average value, a minimum value, a maximum value, and an intermediate value of information associated with the at least two cones selected for the partial area.

Based on a change in a thickness of a cone, information may be successfully incorporated into a portion having opportunity to be a hole in a case of using a ray tracing. A method of rendering based on cone tracing may be used for generating a spontaneous image without a hole by changing the thickness of the cone. The method of rendering may be unlimited on a type of 3D display, and applied when a 3D geometry is determined. The 3D geometry may indicate a stereoscopic, a multi-view, an integral imaging, a light field scheme, and the like. With an application of a method of generating a spontaneous 3D image without a hole to various 3D display architectures, a real-time glasses or glasses-free 3D video may be provided using a low cost.

The methods according to the above-described embodiments may be recorded, stored, or fixed in one or more non-transitory computer-readable media that includes program instructions to be implemented by a computer to cause a processor to execute or perform the program instructions. The media may also include, alone or in combination with the program instructions, data files, data structures, and the like. The program instructions recorded on the media may be those specially designed and constructed, or they may be of the kind well-known and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations and methods described above, or vice versa.

While a few exemplary embodiments have been shown and described with reference to the accompanying drawings, it will be apparent to those skilled in the art that various modifications and variations can be made from the foregoing descriptions.

Thus, other implementations, alternative embodiments and equivalents to the claimed subject matter are construed as being within the appended claims.

What is claimed is:

1. A method of rendering comprising:
generating an image by performing cone tracing indicating beam tracing performed using a cone having a thickness;
determining whether a hole is present in the generated image; and
increasing the thickness when the hole is present in the generated image.

2. The method of claim 1, wherein the generated image is a light field image.

3. The method of claim 2, wherein the rendering is a rendering for an integral imaging.

4. The method of claim 1, wherein the generated image is one of stereoscopic images.

5. The method of claim 1, wherein the generated image is one of multi-view images.

6. The method of claim 1, wherein the generating, the determining, and the increasing are repetitively performed until the hole is no longer present in the generated image.

7. The method of claim 1, wherein when information associated with a plurality of cones arrives at a partial area of the generated image, information associated with a cone selected from among the plurality of cones is used for the partial area based on a predetermined condition.

8. The method of claim 7, wherein the partial area is a pixel included in the generated image.

9. The method of claim 7, wherein the selected cone is a first cone to arrive at the partial area, among the plurality of cones while the generating is being performed repetitively.

10. The method of claim 7, wherein the selected cone is a cone having the smallest distance between a center of the cone and the partial area, among the plurality of cones.

11. The method of claim 7, wherein the selected cone is a cone corresponding to a point having the smallest distance from an observer of the generated image, among points from which the plurality of cones departs.

12. The method of claim 11, wherein the selected cone is determined through a z-buffering on the partial area.

13. The method of claim 1, further comprising:
initializing the thickness of the cone.

14. A non-transitory computer-readable medium comprising a program for instructing a computer to perform the method of claim 1.

15. An apparatus for rendering comprising:
a tracing unit to generate an image by performing cone tracing indicating beam tracing using a cone having a thickness,
wherein the tracing unit determines whether a hole is present in the generated image, and increases the thickness when the hole is present in the generated image.

16. The apparatus of claim 15, wherein the tracing unit repetitively performs the generating, the determining, and the increasing until the hole is no longer present in the generated image.

17. The apparatus of claim 15, further comprising:
a selecting unit to select a cone to be used for a partial area of the generated image, from among a plurality of cones based on a predetermined condition when information associated with the plurality of cones arrives at the partial area of the generated image.

18. The apparatus of claim 17, wherein the selected cone is a first cone to arrive at the partial area, among the plurality of cones, while the generating is being performed repetitively.

19. The apparatus of claim 17, wherein the selected cone is a cone having the smallest distance between a center of the cone and the partial area, among the plurality of cones.

20. An apparatus for rendering comprising:
a tracing unit to generate an image by performing cone tracing indicating beam tracing using a cone having a thickness,
wherein the cone has a thickness adjusted by the tracing unit such that a hole does not occur in the image.
